(19) United States
(12) Patent Application Publication
(10) Pub. No.: US 2011/0197462 A1
(43) Pub. Date: Aug. 18, 2011

(54) Washer/Dryer

(76) Inventor: Levent Hasanreisoglu, Istanbul (TR)

(21) Appl. No.: 13/124,656

(22) PCT Filed: Nov. 11, 2008
(86) PCT No.: PCT/EP2008/065262

§ 371 Date: Apr. 15, 2011

(30) Foreign Application Priority Data
Oct. 16, 2008 (TR) A 2008/07795

(51) Int. Cl. F26B 11/02; D06F 35/00

(52) U.S. Cl. 34/90; 68/19

(57) ABSTRACT

The present invention relates to a washer/dryer (1) that comprises one or more chambers (12) disposed on the drum (2) wherein a sufficient amount of water for counterbalancing the unbalanced load is delivered and stored when there is an unbalanced load.

The present invention relates to a washer/dryer wherein the unbalanced load within the drum is balanced by using a fluid.

In washer/dryers, particularly in washing machines, the laundry is emplaced in a drum, preferably rotating around a horizontal axis. In different steps of the washing program the laundry is cleaned with the help of water and detergent by rotating the drum at different speeds. While the drum is being rotated, the laundry is not distributed homogeneously within the drum and the laundry piles up in some regions causing an uneven load distribution. Particularly in the spinning step wherein the drum is being rotated at high speeds, the unbalanced load distribution generates vibrations. Those vibrations not only generate noise resulting in consumer dissatisfaction but also cause the machine to wear out. Moreover, the spinning performance at high speeds is adversely affected.

In the state of the art, a great number of solutions are developed for balancing the unbalanced load. Of these, a widely used solution is adding weights to the machine for increasing its inertia. However, since fixed weights make the transportation of the machine difficult, in some of the state of the art embodiments, adding a fluid, mostly water, to the machine is suggested. Water is filled in the chambers secured on the tub or the drum. In a group of embodiments, the fluid is added to the machine after transportation and the same fluid is used constantly. In another group of embodiments, the fluid required for balancing is received into the machine during operation and discharged out at the end of the operation.

In the state of the art Japanese Patent Application No JP2002136792, an additional grooved element is described leaning on the shaft bearing that directs water to be delivered to the water storage tanks on the drum when there is unbalanced load. This additional element does not rotate and the water in the groove is delivered to the water storage tanks by means of a channel while the shaft bearing rotates.

The aim of the present invention is the realization of a washer/dryer wherein the unbalanced load is effectively balanced.

The washer/dryer realized in order to attain the aim of the present invention, explicated in the first claim and the respective claims thereof, comprises an immobile circular first protrusion disposed on the tub, a circular second protrusion disposed on the rear wall, rotating together with the drum and surrounding the first protrusion with a space there between, more than one ring shaped wall secured to extend from the outer surface of the first protrusion to the inner surface of the second protrusion and the end pressing on the second protrusion by bearing there against and more than one partition separated by the walls leak-proofingly, defining a volume whereto a distribution line inlet and a feeder line outlet opens to each one joining the distribution and feeder lines.

Since a complete leak-proofing is maintained by means of the walls, a closed system is formed between the partitions. Thus, any kind of loss is prevented during delivering the water coming from the feeder line to the distribution line and the chamber. Moreover, as long as water flows from the feeder line, the incoming water can pass to the distribution line and thus the chamber even while the drum is immobile. That being said, since the first protrusion is immobile, the wall fitted thereon is also immobile. Therefore the abrasion of the wall due to friction is minimized.

In another embodiment of the present invention, the wall comprises a circular carrier seated on the first protrusion and one or more gaskets secured on the carrier providing leak-proofing by bearing against the second protrusion. In another version of the invention, two gaskets are mounted on the same carrier such that the walls of the two adjacent partitions are formed.

In another embodiment of the present invention, the gasket is a double-lipped gasket that extends in opposite directions.

In another embodiment of the present invention, the washer/dryer comprises a first protrusion and a second protrusion, of which the surfaces facing each other are stepped in a matching step shape with the distance there between unchanged. The first and the second protrusion can be easily mounted by means of these steps without the walls being fitted in the grooves.

By means of the present invention, unbalanced load is counterbalanced by mechanically delivering the necessary amount of water to the required region continuously for decreasing the effect to a minimum when the control unit detects a condition of unbalanced load.

A washer/dryer realized in order to attain the aim of the present invention is illustrated in the attached figures, where:

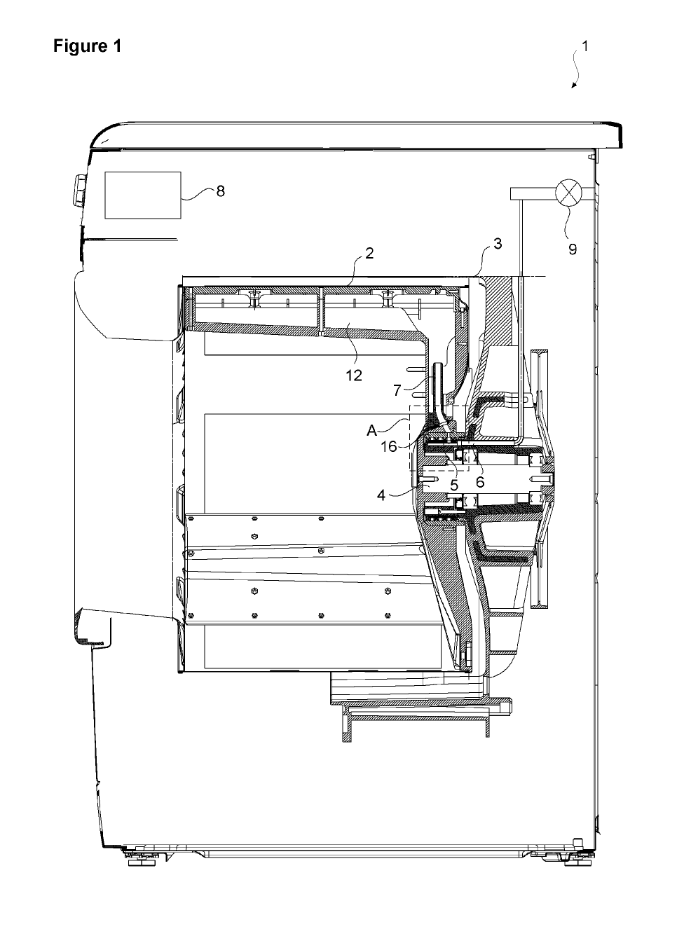

FIG. 1 - is the schematic view of a washer/dryer.

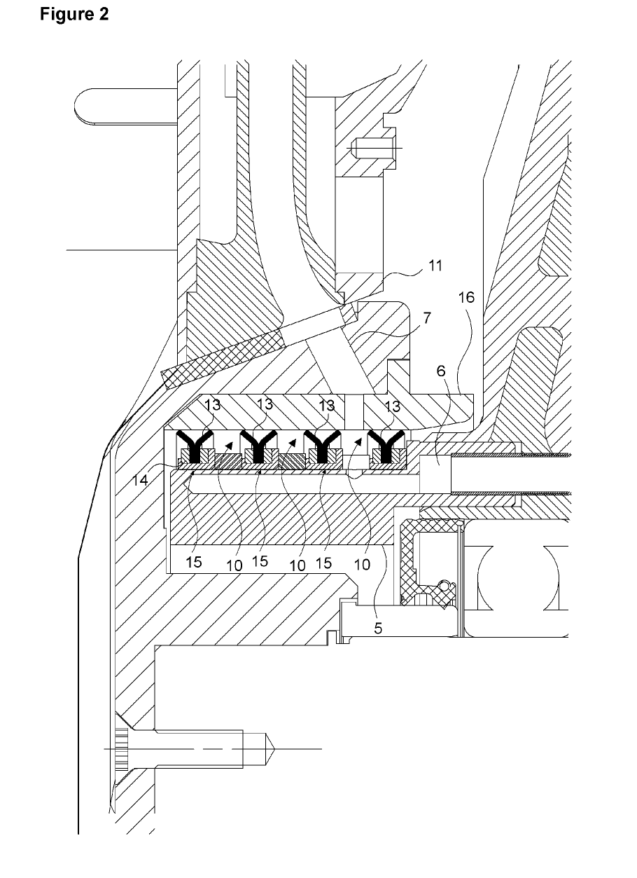

FIG. 2 - is the view of detail A in FIG. 1.

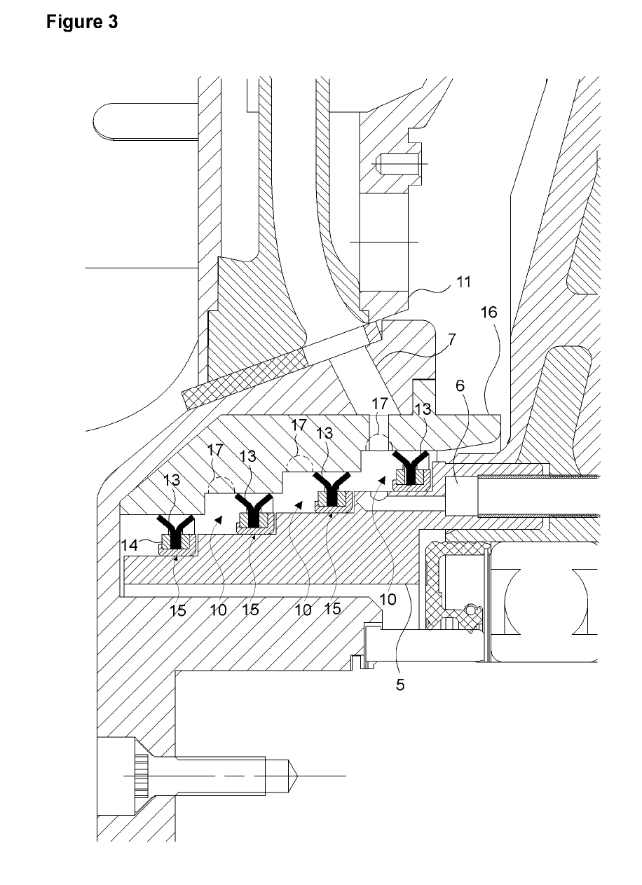

FIG. 3 - is the view of detail A in another embodiment of the present invention.

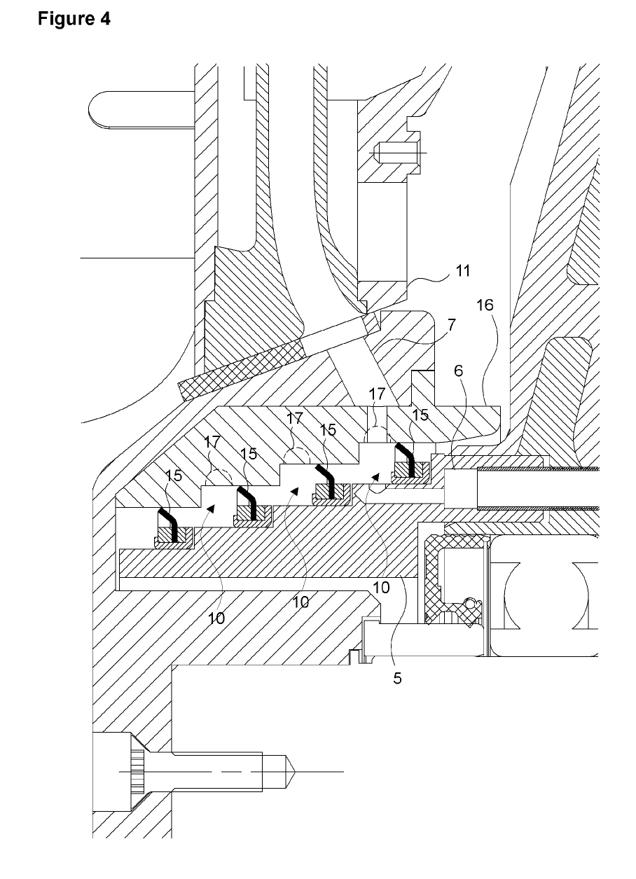

FIG. 4 - is the view of detail A in yet another embodiment of the present invention.

The elements illustrated in the figures are numbered as follows:

1. Washer/dryer

2. Drum

3. Tub

4. Shaft

5. First protrusion

6. Feeder line

7. Distribution line

8. Control unit

9. Valve

10. Partition

11. Rear wall

12. Chamber

13. Gasket

14. Carrier

15. Wall

16. Second protrusion

17. Groove

The washer/dryer (1) of the present invention comprises a rotating drum (2) having a rear wall (11) wherein the items to be washed are emplaced, a tub (3) in which the drum (2) rotates, a motor for rotating the drum (2), a shaft (4) housed on the tub (3) that transfers the movement received from the motor to the drum (2), one or more chambers (12) disposed on the drum (2) whereto fluid is delivered for counterbalancing the unbalanced load when there is a load unbalance, at least one feeder line (6) disposed on the tub (2) having an inlet connected to the main supply and an outlet and at least one distribution line (7) disposed on the rear wall (11), rotating together with the drum (2) and maintaining the connection between the feeder line (6) and the chamber (12).

The washer/dryer (1) furthermore comprises at least one valve (9) situated on each feeder line (6) for controllably receiving water from the main supply to the feeder line (6) and a control unit (8) that identifies the amount and position of the unbalanced load when unbalanced load is detected, deciding the amount of water to be received by each chamber (12) and opens, closes the valves (9) accordingly (FIG. 1).

The washer/dryer (1) comprises:
a circular and immobile first protrusion (5) disposed on the tub (3),
a circular second protrusion (16) disposed on the rear wall (11), rotating together with the drum (2) and surrounding the first protrusion (5) with a space there between,
more than one ring shaped wall (15) secured on the first protrusion (5) to extend from the first protrusion (5) to the second protrusion (16) and the end portion pressing on the surface of the second protrusion (16) by bearing there against and
more than one partition (10), remaining between the walls (15), separated by the walls (15) leak-proofingly, defining a volume whereto one distribution line (7) inlet and one feeder line (6) outlet opens to each one and joining the distribution and feeder lines (6 and 7) (FIG. 2).

The wall (15) is secured on the first protrusion (5) such that it extends towards the second protrusion (16). In this position, the end portion of the walls (15) bear against and press on the surface of the second protrusion (16) facing the surface of the first protrusion (5) whereto the wall (15) is secured. Since the first protrusion (5) is immobile, the wall (15) mounted thereon is also immobile. Therefore, the abrasion of the wall (15) is minimized. Moreover, the wall (15) encloses the partition (10) leak-proofingly and prevents water passage between the partitions (10). Accordingly, the desired amount of water can be delivered to the respective chamber (12) without any leakage and water escape. Plastic, teflon etc. gaskets (13) can be used as the wall (15). A closed system is formed between the partitions (10) since a complete leak-proofing is provided between the partitions (10). Thus, any water escape is prevented during the transfer of water coming from the feeder line (6) to the distribution line (7) and to the chamber (12). Moreover, as long as water flows from the feeder line (6), the incoming water can pass to the distribution line (7) and hence to the chamber (12) even while the drum (2) is immobile.

The outlet of each feeder line (6) opens to a partition (10) surrounded by walls (15) and an inlet of a distribution line (7) is connected to each partition (10). In other words, the outlet of each feeder line (6) and the inlet of each distribution line (7) remains between two walls (15) forming the boundaries of the partition (10). The partition (10) enables the water leaving the feeder line (6) to pass into the distribution line (7). Water is delivered to each chamber (12) by passing through a feeder line (6), a partition (10) and a distribution line (7). Thus, water can be delivered to each chamber (12) independently from each other.

When the washer/dryer (1) is operated, the chamber (12) and the distribution line (7) rotate together with the drum (2). When unbalanced load is detected by the control unit (8), the amount and position of the unbalanced load is specified and the control unit (8) decides the amount of water to be received by each chamber (12) on the drum (2). The control unit (8) enables water to be directed to the chambers (12) in the time determined by opening, closing the valves (9). According to this decision, the valve (9) disposed on the feeder line (6) connected to the main supply opens. Water that flows in the feeder line (6) reaches the outlet of the feeder line (6) and passes from the feeder line (6) outlet into the partition (10). The water inside the partition (10) is directed to the inlet of the distribution line (7). Water received from the partition (10) into the distribution line (7) reaches the respective chamber (12).

In the preferred embodiment of the present invention, three chambers (12) are arranged on the drum (2) having 120° angles there between, three feeder lines (6) on the tub (3) and three distribution lines (7) on the rear wall (11). In this embodiment, moreover, three partitions (10) are disposed side by side whereto the inlet of a distribution line (7) and the outlet of a feeder line (6) open to each one. The feeder lines (6) have different lengths and the outlet of each one opens into a partition (10). Accordingly, depending on which chamber (12) water is intended to be delivered, the valve (9) on the feeder line (6) that delivers water to that chamber (12) is opened.

In another embodiment of the present invention, the wall (15) comprises a circular carrier (14) seated on the first protrusion (5) and one or more gaskets (13) secured on the carrier (14), providing leak-proofing by bearing against the second protrusion (16).

In another version of this embodiment of the present invention, the wall (15) comprises two gaskets (13) mounted on the same carrier (14) forming the walls (15) of two adjacent partitions (10).

In another embodiment of the present invention, the gasket (13) is a double-lipped gasket (13) that extends in opposite directions (FIG. 2 and FIG. 3).

In another embodiment of the present invention, the gasket (13) is folded towards the partition (10) enclosed by itself.

In another embodiment of the present invention, the washer/dryer (1) comprises a sheath whereon more than one wall (15) is disposed in an axial direction at certain intervals. The sheath is fixed on the first protrusion (5). Thus the walls (15) disposed on the sheath are secured on the first protrusion (5). Accordingly, the installation process can be performed more rapidly and easily. Moreover, the distance between the walls (15) can be kept constant during assembly without changing.

In another embodiment of the present invention, the washer/dryer (1) comprises a first protrusion (5) and a second protrusion (16), of which the surfaces facing each other are stepped in a matching step shape with the distance there between unchanged. In a version of this embodiment, a groove (17) is provided on each step of the second protrusion (16) and a wall (15) on each step of the first protrusion (5). The first protrusion (5) can be easily mounted to the second protrusion (16), without mounting the walls (15) to the grooves (17) by means of these steps on the first protrusion (5) and the second protrusion (16) (FIG. 3 and FIG. 4).

By means of the present invention, unbalanced load is counterbalanced by mechanically delivering the necessary amount of water to the required region continuously for decreasing the effect to a minimum when the control unit (8) detects a condition of unbalanced load.

The said invention is not limited by the embodiments explicated above; an expert in the technique can exhibit different embodiments of the present invention. These different embodiments should be evaluated within the scope of the claims of the present invention.

1. A washer/dryer (1) that comprises a rotating drum (2) having a rear wall (11) wherein the items to be washed are emplaced, a tub (3) in which the drum (2) rotates, a motor for rotating the drum (2), a shaft (4) housed on the tub (3) that transfers the movement received from the motor to the drum (2), one or more chambers (12) disposed on the drum (2) whereto fluid is delivered for counterbalancing the unbalanced load when there is a load unbalance, at least one feeder line (6) disposed on the tub (2) having an inlet connected to the main supply and an outlet and at least one distribution line (7) disposed on the rear wall (11), rotating together with the drum (2) and maintaining the connection between the feeder line (6) and the chamber (12) and characterized by—a circular immobile first protrusion (5) disposed on the tub (3),—a circular second protrusion (16) disposed on the rear wall (11), rotating together with the drum (2) and surrounding the first protrusion (5) with a space there between,—more than one ring shaped wall (15) secured on the first protrusion (5) to extend from the first protrusion (5) to the second protrusion (16) and the end portion pressing on the surface of the second protrusion (16) by bearing there against and—more than one partition (10), remaining between the walls (15), separated by the walls (15) leak-proofingly, defining a volume whereto one distribution line (7) inlet and one feeder line (6) outlet opens to each one and joining the distribution and feeder lines (6 and 7).

2. A washer/dryer (1) as in claim 1, characterized by a wall (15) comprising a circular carrier (14) seated on the first protrusion (5) and one or more gaskets (13) secured on the carrier (14), providing leak-proofing by bearing against the second protrusion (16).

3. A washer/dryer (1) as in claim 2, characterized by two gaskets (13) mounted on the same carrier (14) and forming the walls (15) of two adjacent partitions (10).

4. A washer/dryer (1) as in claim 2, characterized by a double-lipped gasket (13) that extends in opposite directions.

5. A washer/dryer (1) as in claim 2, 3 or 4, characterized by a gasket (13) that is folded towards the partition (10) enclosed by itself.

6. A washer/dryer (1) as in any one of the above claims, characterized by a sheath fixed on the first protrusion (5), whereon more than one wall (15) is disposed in an axial direction at certain intervals.

7. A washer/dryer (1) as in any one of the above claims, characterized by a first protrusion (5) and a second protrusion (16), of which the surfaces facing each other are stepped in a matching step shape with the distance there between unchanged.

8. A washer/dryer (1) as in claim 7, characterized by a groove (17) provided on each step of the second protrusion (16) and a wall (15) on each step of the first protrusion (5).
